(19) United States
(12) Patent Application Publication
(10) Pub. No.: US 2018/0275540 A1
(43) Pub. Date: Sep. 27, 2018

(54) TONER

(71) Applicant: CANON KABUSHIKI KAISHA, Tokyo (JP)

(72) Inventors: Ryuichiro Matsuo, Moriya-shi (JP); Masaharu Miura, Toride-shi (JP); Yosuke Iwasaki, Abiko-shi (JP); Wakiko Katsumata, Kashiwa-shi (JP); Kenta Mitsuiki, Toride-shi (JP); Kentaro Kamae, Kashiwa-shi (JP); Takeshi Ohtsu, Toride-shi (JP); Koh Ishigami, Abiko-shi (JP); Yuichi Mizo, Toride-shi (JP)

(21) Appl. No.: 15/919,360

(22) Filed: Mar. 13, 2018

(30) Foreign Application Priority Data
Mar. 21, 2017 (JP) 2017-054301

(51) Int. Cl. G03G 9/08; G03G 9/087

(52) U.S. Cl. CPC G03G 9/0802; G03G 9/08755; G03G 9/0825

(57) ABSTRACT

A toner comprising a toner particle and inorganic fine particles present on the surface of the toner particle, wherein particle diameter numerical distribution of the inorganic fine particles on the toner particle surface has a peak A1 and B1 present in specific particle diameter ranges, the proportion of inorganic fine particles having a particle diameter of 5 nm to 30 nm is not more than 10 number %, after the toner has been subjected to a water wash treatment, the particle diameter numerical distribution of the of the primary particles of the inorganic fine particles on the toner particle surface has a peak A2 and B2 in specific particle diameter ranges; and HB1, which is a peak value of the peak B1, and HB2, which is a peak value of the peak B2, satisfy a specific relationship.

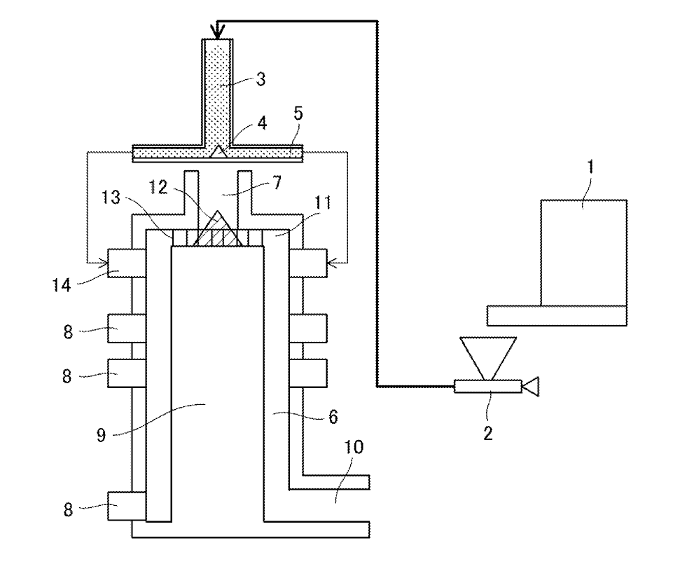

### BACKGROUND OF THE INVENTION

### Field of the Invention

The present invention relates to a toner used in electrophotographic systems, electrostatic recording systems, electrostatic printing systems, and toner jet systems.

In association with the widespread dissemination of electrophotographic system-based full-color copiers, there have been additional increases in the requirements for higher image quality in all types of environments from high-temperature, high-humidity environments to low-temperature, low-humidity environments. The developing performance and transferability of the toner must be increased in order to increase the image quality, and the development is thus required of toner that has an excellent charging behavior and a high charge retentivity. There have also been demands in recent years for higher printer speeds and stability in the printed image, and the development of highly stress-resistant toner is required now more than ever.

The toner particle may be provided with inorganic fine particles, e.g., of metal oxides, known as external additives in order to confer a stable charging behavior on the toner. Moreover, it is known that these inorganic fine particles have the effect of enhancing toner flowability and have the effect of reducing toner adhesiveness by acting as toner-to-toner spacers and spacers between the toner and other members. However, these inorganic fine particles are also known to present the problem of detaching from the toner surface and contaminating other members, and as a consequence it is important that they manifest the aforementioned effects without detaching from the toner surface.

In order to obtain an excellent flowability and transferability without the inorganic fine particles detaching from the toner surface, Japanese Patent Application Laid-open No. 2011-186402 proposes a toner in which small-diameter silica particles and large-diameter silica particles are attached to the surface of the toner base particle and these are fixed by impact force.

In addition, in order to raise the resistance to stress, Japanese Patent Application Laid-open No. 2007-279239 proposes a toner provided by the addition, to 100 mass parts of a toner base particle, of at least 0.5 mass parts and not more than 6.0 mass parts of a silica having a number-average primary particle diameter of at least 35 nm and not more than 300 nm and at least 0.1 mass parts and not more than 3.0 mass parts of a silica having a number-average primary particle diameter of at least 4 nm and not more than 30 nm, followed by a heat-sphering treatment.

### SUMMARY OF THE INVENTION

However, while the invention in Japanese Patent Application Laid-open No. 2011-186402 does have a certain effect with regard to improving the initial transferability, the transferability after the application of stress and the flowability of the toner and developer after the application of stress are not mentioned, and there is room for additional improvement on these points.

A certain effect on the stress resistance of toner is seen with the invention in Japanese Patent Application Laid-open No. 2007-279239, but room for improvement still remains in order to accommodate higher speeds and support two-component development systems, in which the toner is subjected to greater stress.

An object of the present invention is to provide a toner that solves the problems identified above. More specifically, an object of the present invention is to provide a toner that, even during long-term use, supports retention of the flowability of the toner and developer, exhibits an enhanced stress resistance, and generates a high-quality image on a stable basis.

The present invention relates to a toner comprising: a toner particle containing a binder resin and a colorant; and inorganic fine particles present on the surface of the toner particle, wherein particle diameter numerical distribution of primary particles of the inorganic fine particles on the toner particle surface has a peak A1 present in a particle diameter range of at least 35 nm and not more than 55 nm and a peak B1 present in a particle diameter range of at least 80 nm and not more than 135 nm; in this numerical distribution, the proportion of inorganic fine particles in a particle diameter range of at least 5 nm and not more than 30 nm, with reference to a total number of inorganic fine particles in a particle diameter range of at least 5 nm and not more than 200 nm, is not more than 10 number %; after the toner has been subjected to a water wash treatment, the particle diameter numerical distribution of the primary particles of the inorganic fine particles on the toner particle surface has a peak A2 present in a particle diameter range of at least 35 nm and not more than 55 nm and a peak B2 present in a particle diameter range of at least 80 nm and not more than 135 nm;

when HB1 is a peak value of the peak B1 and HB2 is a peak value of the peak B2, 70≤(HB2/HB1)×100≤90 is satisfied; and the water wash treatment is a treatment in which a dispersion obtained by addition of the toner to surfactant-containing deionized water is shaken for 5 minutes under a condition of a shaking speed of 46.7 cm/second and a shaking amplitude of 4.0 cm.

The present invention can thus provide a toner that, even during long-term use, supports retention of the flowability of the toner and developer, exhibits an enhanced stress resistance, and generates a high-quality image on a stable basis.

Further features of the present invention will become apparent from the following description of exemplary embodiments with reference to the attached drawings.

### BRIEF DESCRIPTION OF THE DRAWINGS

The FIGURE is an example of a heat-treatment apparatus.

### DESCRIPTION OF THE EMBODIMENTS

Unless specifically indicated otherwise, the expressions “at least XX and not more than YY” and “XX to YY” that show numerical value ranges refer in the present invention to numerical value ranges that include the lower limit and upper limit that are the end points.

As a result of intensive and extensive investigations, the present inventors discovered that the following are crucial for solving the problems identified above: the presence of peaks in two different ranges in the numerical distribution of the inorganic fine particles present on the toner particle surface, the numerical proportion for the inorganic fine particles in a special particle diameter range, and a special range for the immobilization ratio for the inorganic fine particles for prior to a water wash treatment versus after a water wash treatment. The present invention was achieved based on this discovery.

Thus, the following are crucial for a toner having: a toner particle containing a binder resin and a colorant; and inorganic fine particles present on the surface of the toner particle, wherein particle diameter numerical distribution of primary particles of the inorganic fine particles on the toner particle surface has a peak A1 present in a particle diameter range of at least 35 nm and not more than 55 nm and a peak B1 present in a particle diameter range of at least 80 nm and not more than 135 nm; in this numerical distribution, the proportion of inorganic fine particles in a particle diameter range of at least 5 nm and not more than 30 nm, with reference to a total number of inorganic fine particles in a particle diameter range of at least 5 nm and not more than 200 nm, is not more than 10 number %; after the toner has been subjected to a water wash treatment, the particle diameter numerical distribution of primary particles of the inorganic fine particles on the toner particle surface has a peak A2 present in a particle diameter range of at least 35 nm and not more than 55 nm and a peak B2 present in a particle diameter range of at least 80 nm and not more than 135 nm; and when HB1 is a peak value of the peak B1 and HB2 is a peak value of the peak B2, 70≤(HB2/HB1)×100≤90 is satisfied.

It was found that when the state of occurrence of the inorganic fine particles on the toner particle surface is made the state described above, in comparison to toner in which this state is not met, even during long-term use the flowability of the toner and developer can be retained, the stress resistance is enhanced, and a high-quality image is obtained on a stable basis.

The present inventors hypothesize the following for the mechanisms by which these effects are generated.

In order for the aforementioned peak A1 and peak B1 to be generated in the numerical distribution of the diameter of the primary particles of the inorganic fine particles on the toner particle surface, preferably two species of inorganic fine particles having different number-average primary particle diameters are attached to the toner particle surface prior to heat treatment. By adopting the aforementioned ranges for the particle dimeters of the two species of inorganic fine particles, small-diameter inorganic fine particles are then dispersed on the toner particle surface and the movement of the large-diameter inorganic fine particles is restricted. As a consequence, the durability of the toner is improved due to the uniform dispersion of the two species of inorganic fine particles on the toner particle surface. In addition, it is thought that, by having the inorganic fine particles constituting the peak A1 have a certain size, burial of the inorganic fine particles during heat treatment and also after the application of stress during actual use is suppressed and a high flowability can then be maintained.

The peak A1 in the numerical distribution of the particle diameter of the primary particles of the inorganic fine particles must be present at a particle diameter of at least 35 nm and not more than 55 nm. At less than 35 nm, many of the inorganic fine particles end up being completely buried after heat treatment or the application of stress and the flowability of the developer cannot be maintained and the density may then end up varying when large changes in the image ratio occur. On the other hand, at larger than 55 nm, the developer flowability is low from prior to the application of stress and streaks may be produced in the image when stress is applied. The peak A1 preferably is present at a particle diameter of at least 40 nm and not more than 50 nm.

At least 3.0 mass parts and not more than 7.0 mass parts per 100 mass parts of the toner particle is the preferred content of inorganic fine particles having a number-average particle diameter of at least 35 nm and not more than 55 nm and being capable of constituting the peak A1.

The peak B1 in the numerical distribution of the particle diameter of the primary particles of the inorganic fine particles must be present at a particle diameter of at least 80 nm and not more than 135 nm. At less than 80 nm, it may not be possible to maintain an excellent flowability after the application of stress. At greater than 135 nm, on the other hand, many particles will not be fixed or immobilized after heat treatment and may ultimately attach to the carrier or charging roller. The peak B1 preferably is present at a particle diameter of at least 85 nm and not more than 130 nm.

At least 2.5 mass parts and not more than 7.5 mass parts per 100 mass parts of the toner particle is the preferred content of inorganic fine particles having a number-average particle diameter of at least 80 nm and not more than 135 nm and being capable of constituting the peak B1.

The inorganic fine particle content, per 100 mass parts of the toner particle, is preferably at least 1.0 mass part and not more than 20.0 mass parts and is more preferably at least 3.0 mass parts and not more than 15.0 mass parts.

It is crucial that the proportion of inorganic fine particles in the particle diameter range of at least 5 nm and not more than 30 nm, with reference to the total number of inorganic fine particles in the particle diameter range of at least 5 nm and not more than 200 nm, is not more than 10 number % in the numerical distribution of the particle diameter of the primary particles of the inorganic fine particles. At larger than 10 number %, the durability of the toner during long-term use may decline. The population of these inorganic fine particles is preferably not more than 7 number %. On the other hand, the lower limit is not particularly limited, but is preferably at least 1 number %.

In addition, it is essential that, after the toner has been subjected to the water wash treatment, the numerical distribution of the particle diameter of the primary particles of the inorganic fine particles on the toner particle surface has a peak A2 present in the particle diameter range of at least 35 nm and not more than 55 nm and a peak B2 present in the particle diameter range of at least 80 nm and not more than 135 nm. By adopting this, the inorganic fine particles will not detach even during long-term use and the same properties as at the start of use can be maintained.

The peak A2 is preferably present at a particle diameter of at least 40 nm and not more than 50 nm. The peak B2 is preferably present at a particle diameter of at least 85 nm and not more than 130 nm.

The water wash treatment is a water wash treatment in which a dispersion provided by the addition of the toner to surfactant-containing deionized water is shaken for 5 minutes using conditions of a shaking speed of 46.7 cm/second and a shaking amplitude of 4.0 cm. Considered in detail, a dispersion is prepared by introducing, into a 30-cc glass vial (for example, VCV-30 from Nichiden-Rika Glass Co., Ltd., outer diameter: 35 mm, height: 70 mm), 6 cc of the surfactant Contaminon N (neutral pH 7 detergent for cleaning precision measurement instrumentation, comprising a nonionic surfactant, anionic surfactant, and organic builder, Wako Pure Chemical Industries, Ltd.) into an aqueous sucrose solution of 20.7 g of sucrose (Kishida Chemical Co., Ltd.) dissolved in 10.3 g of deionized water, and thoroughly mixing. 1.0 g of the toner is added to this vial and standing at quiescence is carried out until the toner has naturally sedimented, thus yielding the pre-treatment dispersion. This dispersion is shaken for 5 minutes at a shaking rate of 200 rpm using a shaker (YS-8D, Yayoi Co., Ltd.).

For the toner prior to the water wash treatment versus the toner after the water wash treatment, it is crucial that the relationship between the peak value HB1 (number %) of the peak B1 and the peak value HB2 (number %) of the peak B2 satisfies 70≤(HB2/HB1)×100≤90. When (HB2/HB1)×100<70, the inorganic fine particles readily detach from the toner particle surface and image defects caused by attachment to the magnetic carrier and/or the charging roller may be produced. When 90<(HB2/HB1)×100, image defects caused by cleaning defects may be produced, particularly when used in combination with a high-hardness drum. Preferably 72≤(HB2/HB1)×100≤88 is satisfied.

In addition, HB1 is preferably at least 6.5 number % and not more than 13.0 number % and HB2 is preferably at least 5.5 number % and not more than 10.5 number %.

With regard to the toner after the water wash treatment, the immobilization percentage of the inorganic fine particles on the toner particle surface is preferably at least 70%. At less than 70%, image defects caused by attachment of the inorganic fine particles to the magnetic carrier and/or charging roller can be generated. The immobilization percentage is preferably at least 75%. The upper limit is not particularly limited, but it is preferably equal to or less than 95%.

Heretofore known inorganic fine particles, e.g., of titanium oxide, silica, alumina, and so forth, are preferably used for the inorganic fine particles, while the inclusion of silica fine particles is more preferred. The silica fine particles can be wet silica provided by, for example, a precipitation method or sol-gel method, or a dry silica provided by, for example, a deflagration method or fume method, but dry silicas are more preferred for the ease of shape control.

For example, a silicon halide compound is the starting material for a dry silica.

Silicon tetrachloride may be used as the silicon halide compound, but a silane by itself, e.g., methyltrichlorosilane, trichlorosilane, and so forth, may also be used as the starting material or the silane mixed with silicon tetrachloride may also be used as the starting material.

After the starting material has been vaporized, the target silica is obtained by what is known as a flame hydrolysis reaction, i.e., a reaction with the water produced as an intermediate in an oxyhydrogen flame.

For example, the reaction equation is as follows for use of the thermal decomposition oxidation reaction of a silicon tetrachloride gas in oxygen and hydrogen.

SiCl₄+2H₂+O₂→SiO₂+4HCl

An example of the production of a dry silica that can be used by the present invention is described in the following.

Oxygen gas is supplied to a burner; the ignition burner is ignited; hydrogen gas is then supplied to the burner to form a flame; and the silicon tetrachloride starting material is introduced thereinto and is gasified. The flame hydrolysis reaction is then carried out and the produced silica powder is recovered.

The diameter and shape of the primary particles can be adjusted as desired through judicious alterations in the silicon tetrachloride flow rate, oxygen gas feed flow rate, hydrogen gas feed flow rate, and residence time by the silica in the flame.

Other Inorganic Fine Particles

To the degree that the effects of the present invention are not impaired, the toner of the present invention may also contain additional inorganic fine particles. These inorganic fine particles may be internally added or externally added to the toner particle. Silica, titanium oxide, aluminum oxide, strontium titanate, and so forth are preferred for the external additive. The inorganic fine particles are preferably hydrophobed using a hydrophobic agent such as a silane compound, silicone oil, or their mixture.

These other inorganic fine particles are preferably used at at least 0.1 mass parts and not more than 10.0 mass parts per 100 mass parts of the toner particle. The toner particle can be mixed with the other inorganic fine particles using a known mixer such as a Henschel mixer. The toner particle may be mixed with the other inorganic fine particles before the heat treatment or after the heat treatment.

Binder Resin

A known binder resin, e.g., a polyester resin or vinyl resin, can be used for the binder resin used in the toner of the present invention. The binder resin preferably has polyester resin as its main component. Here, main component indicates a content of at least 50 mass %.

A polyhydric alcohol (dihydric or at least trihydric alcohol) and a polybasic carboxylic acid (dibasic or at least tribasic carboxylic acid) or anhydride or lower alkyl ester thereof are used as the monomer used for the polyester resin. When a branched polymer is to be produced, a partial branching within the binder resin molecule is effective for this and for this purpose the use is preferred of an at least trivalent polyfunctional compound. Accordingly, the starting monomer for the polyester resin preferably contains an at least tribasic carboxylic acid or anhydride or lower alkyl ester thereof, and/or an at least trihydric alcohol.

The following polyhydric alcohol monomers can be used as the polyhydric alcohol monomer used for the polyester resin.

The dihydric alcohol component can be exemplified by ethylene glycol, propylene glycol, 1,3-butanediol, 1,4-butanediol, 2,3-butanediol, diethylene glycol, triethylene glycol, 1,5-pentanediol, 1,6-hexanediol, neopentyl glycol, 2-ethyl-1,3-hexanediol, hydrogenated bisphenol A, bisphenols having formula (A) and derivatives thereof:

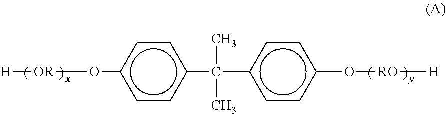

(in the formula, R is an ethylene or propylene group; x and y are each integers equal to or greater than 0; and the average value of x+y is at least 0 and not more than 10), and

diols having formula (B)

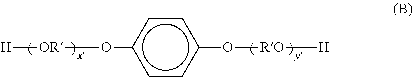

(in the formula, R′ represents —CH₂CH₂—,

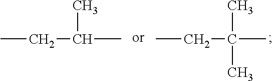

x′ and y′ are each integers equal to or greater than 0; and the average value of x′+y′ is 0 to 10).

The at least trihydric alcohol component can be exemplified by sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene. Among the preceding, the use of glycerol, trimethylolpropane, and pentaerythritol is preferred. A single one of these dihydric alcohols may be used or a plurality may be used in combination, and a single one of these at least trihydric alcohols may be used or a plurality may be used in combination.

The following polybasic carboxylic acid monomers can be used as the polybasic carboxylic acid monomer used for the polyester resin.

The dibasic carboxylic acid component can be exemplified by maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecenylsuccinic acid, isododecenylsuccinic acid, n-dodecylsuccinic acid, isododecylsuccinic acid, n-octenylsuccinic acid, n-octylsuccinic acid, isooctenylsuccinic acid, isooctylsuccinic acid, and the anhydrides and lower alkyl esters of these acids. Among the preceding, the use of maleic acid, fumaric acid, terephthalic acid, and n-dodecenylsuccinic acid is preferred.

The at least tribasic carboxylic acids and their anhydrides and lower alkyl esters can be exemplified by 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, and Empol trimer acid and their anhydrides and lower alkyl esters. Among the preceding, the use is preferred in particular of 1,2,4-benzenetricarboxylic acid, i.e., trimellitic acid, and derivatives thereof because they are inexpensive and support facile control of the reaction. A single one of these dibasic carboxylic acids may be used or a plurality may be used in combination, and a single one of the at least tribasic carboxylic acids may be used or a plurality may be used in combination.

This may be a hybrid resin containing another resin component as long as polyester resin is the main component. An example is a hybrid resin of a polyester resin and a vinyl resin. In a preferred method for obtaining such a hybrid resin in the form of the reaction product of a polyester resin and a vinyl resin or vinyl copolymer unit, the polymerization reaction of either or both resins is carried out in the presence of a polymer that contains monomer component that can react with each of the polyester resin and vinyl resin or vinyl copolymer unit.

For example, among monomers that can constitute a polyester resin component, examples of monomer that can react with a vinyl copolymer are unsaturated dicarboxylic acids such as fumaric acid, maleic acid, citraconic acid, and itaconic acid and their anhydrides. Among monomers that can constitute a vinyl copolymer component, monomer that can react with the polyester resin component can be exemplified by monomer bearing the carboxyl group or hydroxyl group and acrylic acid or methacrylic acid esters.

Known resins may be used as the binder resin, either in addition to polyester resin or by themselves. Such resins can be exemplified by homopolymers of styrene and substituted styrenes, such as polystyrene, poly-p-chlorostyrene, and polyvinyltoluene; styrenic copolymers such as styrene-p-chlorostyrene copolymers, styrene-vinyltoluene copolymers, styrene-vinylnaphthalene copolymers, styrene-acrylate ester copolymers, styrene-methacrylate ester copolymers, styrene-methyl α-chloromethacrylate copolymers, styrene-acrylonitrile copolymers, styrene-vinyl methyl ether copolymers, styrene-vinyl ethyl ether copolymers, styrene-vinyl methyl ketone copolymers, and styrene-acrylonitrile-indene copolymers; as well as polyvinyl chloride, phenolic resins, natural resin-modified phenolic resins, natural resin-modified maleic resins, acrylic resins, methacrylic resins, polyvinyl acetate resins, silicone resins, polyurethane resins, polyamide resins, furan resins, epoxy resins, xylene resins, polyvinyl butyral resins, terpene resins, coumarone-indene resins, and petroleum resins.

Viewed from the standpoints of the low-temperature fixability and hot offset resistance, the peak molecular weight of the binder resin is preferably at least 5,000 and not more than 13,000. In addition, the acid value of the binder resin is preferably not more than 10 mg KOH/g from the standpoint of the charge stability in high-temperature, high-humidity environments.

A mixture of a low molecular weight binder resin E and a high molecular weight binder resin D may be used for the binder resin. Viewed from the standpoints of the low-temperature fixability and the hot offset resistance, the content ratio (D/E) between the high molecular weight binder resin D and the low molecular weight binder resin E is preferably at least 10/90 and not more than 60/40 on a mass basis.

The peak molecular weight of the high molecular weight binder resin D is preferably at least 10,000 and not more than 20,000 from the standpoint of the hot offset resistance. Viewed in terms of the charge stability in high-temperature, high-humidity environments, the acid value of the high molecular weight binder resin is preferably at least 15 mg KOH/g and not more than 30 mg KOH/g.

The number-average molecular weight of the low molecular weight binder resin E is preferably at least 1,500 and not more than 3,500 from the standpoint of the low-temperature fixability. Viewed in terms of the charge stability in high-temperature, high-humidity environments, the acid value of the low molecular weight binder resin is preferably not more than 10 mg KOH/g.

A crystalline polyester resin may be added to the toner particle with the goal of promoting the plasticizing effect in the toner and improving the low-temperature fixability.

An example of the crystalline polyester is the polycondensate of a monomer composition that contains, as its main component, an aliphatic diol having at least 2 and not more than 22 carbons and an aliphatic dicarboxylic acid having at least 2 and not more than 22 carbons.

There are no particular limitations on the aliphatic diol having at least 2 and not more than 22 carbons (more preferably at least 6 and not more than 12 carbons), but a chain (more preferably a straight chain) aliphatic diol is preferred. Particularly preferred examples are straight-chain aliphatic α,ω-diols such as ethylene glycol, diethylene glycol, 1,4-butanediol, and 1,6-hexanediol.

Preferably at least 50 mass % and more preferably at least 70 mass % of the alcohol component is alcohol selected from aliphatic diols having at least 2 and not more than 22 carbons.

There are also no particular limitations on the aliphatic dicarboxylic acid having at least 2 and not more than 22 carbons (more preferably at least 6 and not more than 12 carbons), but a chain (preferably a straight chain) aliphatic dicarboxylic acid is preferred. Preferably at least 50 mass % and more preferably at least 70 mass % of the carboxylic acid component is carboxylic acid selected from aliphatic dicarboxylic acids having at least 2 and not more than 22 carbons.

The crystalline polyester can be produced according to the usual methods of polyester synthesis.

Colorant

Colorant that can be incorporated in the toner is exemplified by the following.

Black colorants can be exemplified by carbon black and black colorants provided by coloring mixing using a yellow colorant, a magenta colorant, and a cyan colorant to give a black color. A pigment may be used by itself for the colorant. The sharpness can be enhanced when a dye/pigment combination is used, and this is thus preferred from the perspective of the image quality of the full-color image.

Pigments for magenta toners can be exemplified by the following: C. I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, and 282; C. I. Pigment Violet 19; and C. I. Vat Red 1, 2, 10, 13, 15, 23, 29, and 35.

Dyes for magenta toners can be exemplified by the following: oil-soluble dyes such as C. I. Solvent Red 1, 3, 8, 23, 24, 25, 27, 30, 49, 81, 82, 83, 84, 100, 109, and 121; C. I. Disperse Red 9; C. I. Solvent Violet 8, 13, 14, 21, and 27; and C. I. Disperse Violet 1, and basic dyes such as C. I. Basic Red 1, 2, 9, 12, 13, 14, 15, 17, 18, 22, 23, 24, 27, 29, 32, 34, 35, 36, 37, 38, 39, and 40; and C. I. Basic Violet 1, 3, 7, 10, 14, 15, 21, 25, 26, 27, and 28.

Pigments for cyan toners can be exemplified by the following: C. I. Pigment Blue 2, 3, 15:2, 15:3, 15:4, 16, and 17; C. I. Vat Blue 6; C. I. Acid Blue 45; and copper phthalocyanine pigments in which from 1 to 5 phthalimidomethyl groups are substituted on the phthalocyanine skeleton.

C. I. Solvent Blue 70 is a dye for cyan toners.

Pigments for yellow toners can be exemplified by the following: C. I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, and 185; and C. I. Vat Yellow 1, 3, and 20. C. I. Solvent Yellow 162 is a dye for yellow toners.

The use amount for the colorant is preferably at least 0.1 mass parts and not more than 30 mass parts per 100 mass parts of the binder resin.

Developer

The toner of the present invention may be used as a single-component developer; however, in order to bring about additional improvements in the dot reproducibility, use as a two-component developer provided by mixing with a magnetic carrier is preferred with regard to obtaining a stable image on a long-term basis.

A commonly known magnetic carrier can be used as the magnetic carrier here, for example, surface-oxidized iron powder or unoxidized iron powder; metal particles such as those of iron, lithium, calcium, magnesium, nickel, copper, zinc, cobalt, manganese, chromium, and rare earths, and their alloy particles and oxide particles; magnetic bodies such as ferrite; and magnetic body-dispersed resin carriers (known as resin carriers), which contain a magnetic body and a binder resin that maintains the magnetic body in a dispersed state.

Excellent results are generally obtained when the mixing ratio between the toner and magnetic carrier, expressed as the toner concentration in the two-component developer, is preferably at least 2 mass % and not more than 15 mass % and more preferably at least 4 mass % and not more than 13 mass %.

Production Method

A known method can be used as the method of producing the toner particle, e.g., melt-kneading methods, phase inversion emulsification methods, suspension polymerization methods, and emulsion aggregation methods. Viewed from the standpoint of achieving a microfine dispersion of materials such as the colorant and so forth in the binder resin, a melt-kneading method—wherein the binder resin, colorant, and other optional additives are melt-kneaded and the kneaded material is cooled and then pulverized and classified—is preferred.

A toner production procedure using a melt-kneading method is described in the following.

In a starting material mixing step, the materials that will constitute the toner particle, for example, the binder resin and colorant and other optional components such as wax and charge control agent, are metered out in prescribed amounts and blended and mixed. The mixing device can be exemplified by the double cone mixer, V-mixer, drum mixer, Super mixer, Henschel mixer, Nauta mixer, and Mechano Hybrid (Nippon Coke & Engineering Co., Ltd.).

The mixed materials are then subjected to melt-kneading in order to disperse the colorant and so forth in the binder resin. A batch kneader such as a pressure kneader or Banbury mixer or a continuous kneader can be used in this melt-kneading step, and single-screw and twin-screw extruders have become the main stream here due to their advantage of enabling continuous production. Examples are the Model KTK twin-screw extruder (Kobe Steel, Ltd.), Model TEM twin-screw extruder (Toshiba Machine Co., Ltd.), PCM kneader (Ikegai Corporation), Twin Screw Extruder (KCK Co., Ltd.), Co-Kneader (Buss AG), and Kneadex (Nippon Coke & Engineering Co., Ltd.). The resin composition yielded by melt-kneading may additionally be rolled out using, for example, a two-roll mill, and cooled in a cooling step, for example, with water.

The cooled resin composition is then pulverized to the desired particle diameter in a pulverization step. In the pulverization step, for example, a coarse pulverization is performed using a grinder such as a crusher, hammer mill, or feather mill, followed, for example, by a fine pulverization using a pulverizer such as a Kryptron System (Kawasaki Heavy Industries, Ltd.), Super Rotor (Nisshin Engineering Inc.), or Turbo Mill (Turbo Kogyo Co., Ltd.) or using an air jet system.

A classified product (the toner particle) is then obtained as necessary by carrying out classification using a sieving apparatus or a classifier, e.g., an internal classification system such as the Elbow Jet (Nittetsu Mining Co., Ltd.) or a centrifugal classification system such as the Turboplex (Hosokawa Micron Corporation), TSP Separator (Hosokawa Micron Corporation), or Faculty (Hosokawa Micron Corporation). Among the preceding, the Faculty (Hosokawa Micron Corporation) is preferred because it can carry out a sphering treatment on the toner particle at the same time as classification, thus improving the transfer efficiency.

The method of producing the toner according to the present invention preferably includes a step of carrying out the external addition of inorganic fine particles to the surface of the resulting toner particle and executing a heat treatment. With regard to the method for adding the inorganic fine particles to the toner particle, the toner particle and inorganic fine particles are blended in prescribed amounts and are stirred and mixed using an external addition apparatus in the form of a high-speed stirrer that applies shear force to powder, e.g., Henschel mixer, Mechano Hybrid (Nippon Coke & Engineering Co., Ltd.), Super mixer, and Nobilta (Hosokawa Micron Corporation).

The addition is preferred of inorganic fine particles having a number-average particle diameter of at least 35 nm and not more than 55 nm that can constitute the peak A1 and inorganic fine particles having a number-average particle diameter of at least 80 nm and not more than 135 nm that can constitute the peak B1.

Then, in a heat treatment step, the obtained particles are subjected to a heat treatment using a heat-treatment apparatus as shown in the FIGURE to bring about a thermal immobilization or fixing of the inorganic fine particles to the toner particle surface. An additional external addition and mixing of inorganic fine particles after the heat treatment is also a preferred embodiment. The inorganic fine particles added after the heat treatment are preferably inorganic fine particles having a number-average particle diameter of at least 80 nm and not more than 135 nm that can constitute the peak B1.

The mixture, which is metered and fed by a starting material metering and feed means 1, is conducted, by a compressed gas adjusted by a compressed gas adjustment means 2, to an introduction tube 3 that is disposed on the vertical line of a starting material feed means. The mixture that has passed through the introduction tube is uniformly dispersed by a conical projection member 4 that is disposed at the center of the starting material feed means and is introduced into an 8-direction feed tube 5 that extends radially and is introduced into a treatment compartment 6 in which the heat treatment is performed.

At this point, the flow of the mixture fed into the treatment compartment is regulated by a regulation means 9 that is disposed within the treatment compartment in order to regulate the flow of the mixture. As a result, the mixture fed into the treatment compartment is heat treated while rotating within the treatment compartment and is thereafter cooled.

The heat for carrying out the heat treatment of the introduced mixture is fed from a hot air current feed means 7 and is distributed by a distribution member 12, and the hot air current is introduced into the treatment compartment having been caused to undergo a spiral rotation by a rotation member 13 for imparting rotation to the hot air current. With regard to its structure, the rotation member 13 for imparting rotation to the hot air current has a plurality of blades, and the rotation of the hot air current can be controlled using their number and angle. The hot air current fed into the treatment compartment has a temperature at the outlet of the hot air current feed means 7 of preferably 100° C. to 300° C. and more preferably 130° C. to 250° C. When the temperature at the outlet of the hot air current feed means resides in the indicated range, toner particles can be uniformly spherized while the melt adhesion and coalescence of the toner particles that would be induced by an excessive heating of the mixture can be prevented. The hot air current is fed from a hot air current feed means outlet 11.

In addition, the heat-treated toner particles that have been heat treated are cooled by a cold air current fed from a cold air current feed means 8, and the temperature fed from the cold air current feed means 8 is preferably −20° C. to 30° C. When the cold air current temperature resides in this range, the heat-treated toner particles can be efficiently cooled and melt adhesion and coalescence of the heat-treated toner particles can be prevented without impairing the uniform heat-sphering treatment of the mixture. The absolute amount of moisture in the cold air current is preferably at least 0.5 g/m³ and not more than 15.0 g/m³.

The cooled heat-treated toner particles are then recovered by a recovery means 10 residing at the lower end of the treatment compartment. A blower (not shown) is disposed at the end of the recovery means and thereby forms a structure that carries out suction transport.

In addition, a powder particle feed port 14 is disposed so the rotational direction of the incoming mixture is the same direction as the rotational direction of the hot air current, and the recovery means 10 for the surface-treatment apparatus is disposed at the periphery of the treatment compartment so as to maintain the rotational direction of the rotating powder particles. In addition, the cold air current fed from the cold air current feed means 8 is configured to be fed from a horizontal and tangential direction from the periphery of the apparatus to the circumferential surface within the treatment compartment. The rotational direction of the pre-heat-treatment toner particles fed from the powder feed port, the rotational direction of the cold air current fed from the cold air current feed means, and the rotational direction of the hot air current fed from the hot air current feed means are all the same direction. As a consequence, flow perturbations within the treatment compartment do not occur; the rotational flow within the apparatus is reinforced; a strong centrifugal force is applied to the toner particles prior to the heat treatment; and the dispersity of the toner particles prior to the heat treatment is further enhanced, as a result of which there are few coalesced particles and heat-treated toner particles with a uniform shape can be obtained.

When coarse particles are present after the heat treatment, as necessary the coarse particles may be removed by classification. Classifiers for coarse particle removal are exemplified by classifiers such as the Turboplex, TSP, TTSP, and Cliffis (Hosokawa Micron Corporation) and the Elbow Jet (Nittetsu Mining Co., Ltd.).

In addition, after the heat treatment, a screening device, for example, Ultrasonic (Koei Sangyo Co., Ltd.), Rezona Sieve and Gyro-Sifter (Tokuju Corporation), Turbo Screener (Turbo Kogyo Co., Ltd.), Hi-Bolter (Toyo Hitec Co., Ltd.), and so forth may be used to screen out the coarse particles.

The heat treatment step may be run after the aforementioned fine pulverization.

The average circularity of the toner according to the present invention is preferably at least 0.955 and more preferably at least 0.960. The transfer efficiency of the toner is improved by adopting this range for the average circularity of the toner.

The methods used to measure the various properties of the toners and starting materials are described below.

### Method for Measuring the Number-Average Particle Diameter (D1) of the Primary Particles

The number-average particle diameter of the primary particles of the inorganic fine particles is measured using a “JEM2800” (JEOL Ltd.) transmission electron microscope (TEM).

The measurement sample is first prepared. 1 mL of isopropanol is added to approximately 5 mg of the inorganic fine particles and dispersion is carried out for 5 minutes using an ultrasound disperser (ultrasound cleaner). One drop of this dispersion is placed on a microgrid (150 mesh) carrying a TEM support film, and the measurement sample is then prepared by drying.

Using the transmission electron microscope (TEM), an image is then acquired using an acceleration voltage condition of 200 kV at a magnification (for example, 200,000× to 1,000,000×) at which the length of the external additive in the visual field can be satisfactorily measured; the long diameter is measured on 100 randomly selected primary particles of the inorganic fine particles; and the number-average particle diameter thereof is determined. Measurement of the primary particle diameter may be done manually or using a measurement tool.

Method for Measuring the Weight-Average Molecular Weight of the Resins

The molecular weight distribution of the THF-soluble matter of the resins was measured as follows using gel permeation chromatography (GPC).

First, the resin was dissolved in tetrahydrofuran (THF) over 24 hours at room temperature. The obtained solution was then filtered across a “Sample Pretreatment Cartridge” solvent-resistant membrane filter with a pore diameter of 0.2 μm (Tosoh Corporation) to obtain the sample solution. The sample solution was adjusted to a THF-soluble component concentration of approximately 0.8 mass %. The measurement was performed under the following conditions using this sample solution.

instrument: HLC8120 GPC (detector: RI) (Tosoh Corporation)
columns: 7-column train of Shodex KF-801, 802, 803, 804, 805, 806, and 807 (from Showa Denko K.K.)
eluent: tetrahydrofuran (THF)
flow rate: 1.0 mL/minute
oven temperature: 40.0° C.
sample injection amount: 0.10 mL

A molecular weight calibration curve constructed using polystyrene resin standards (for example, product name “TSK Standard Polystyrene F-850, F-450, F-288, F-128, F-80, F-40, F-20, F-10, F-4, F-2, F-1, A-5000, A-2500, A-1000, A-500”, Tosoh Corporation) was used to determine the molecular weight of the sample.

Method for Measuring the Weight-Average Particle Diameter (D4) of the Toner Particle

Using a “Coulter Counter Multisizer 3” (registered trademark, Beckman Coulter, Inc.), a precision particle size distribution measurement instrument operating on the pore electrical resistance method and equipped with a 100 μm aperture tube, and using the accompanying dedicated software, i.e., “Beckman Coulter Multisizer 3 Version 3.51” (Beckman Coulter, Inc.), for setting the measurement conditions and analyzing the measurement data, the weight-average particle diameter (D4) of the toner particle was determined by performing the measurement in 25,000 channels for the number of effective measurement channels and analyzing the measurement data.

The aqueous electrolyte solution used for the measurements was prepared by dissolving special-grade sodium chloride in deionized water to provide a concentration of approximately 1 mass %, and, for example, “ISOTON II” (Beckman Coulter, Inc.) can be used.

The dedicated software was configured as follows prior to measurement and analysis.

In the “modify the standard operating method (SOM)” screen in the dedicated software, the total count number in the control mode was set to 50,000 particles; the number of measurements was set to 1 time; and the Kd value was set to the value obtained using “10.0 μm standard particles” (Beckman Coulter, Inc.). The threshold value and noise level were automatically set by pressing the threshold value/noise level measurement button. The current was set to 1,600 μA; the gain was set to 2; the electrolyte was set to ISOTON II; and a check was entered for the post-measurement aperture tube flush.

In the “setting conversion from pulses to particle diameter” screen of the dedicated software, the bin interval was set to logarithmic particle diameter; the particle diameter bin was set to 256 particle diameter bins; and the particle diameter range was set to at least 2 μm and not more than 60 μm.

The specific measurement procedure is as follows.

(1) Approximately 200 mL of the above-described aqueous electrolyte solution was introduced into a 250-mL roundbottom glass beaker intended for use with the Multisizer 3 and this was placed in the sample stand and counterclockwise stirring with the stirrer rod was carried out at 24 rotations per second. Contamination and air bubbles within the aperture tube were removed in advance by the “aperture flush” function of the dedicated software.

(2) Approximately 30 mL of the above-described aqueous electrolyte solution was introduced into a 100-mL flatbottom glass beaker. To this was added, as a dispersing agent, approximately 0.3 mL of a dilution prepared by the three-fold (mass) dilution with deionized water of “Contaminon N” (a 10 mass % aqueous solution of a neutral pH 7 detergent for cleaning precision measurement instrumentation comprising a nonionic surfactant, anionic surfactant, and organic builder, Wako Pure Chemical Industries, Ltd.).

(3) Deionized water was introduced in a prescribed amount into the water tank of an “Ultrasonic Dispersion System Tetora 150” ultrasound disperser (Nikkaki Bios Co., Ltd.), which is an ultrasound disperser that has an electrical output of 120 W and is equipped with two oscillators that have an oscillation frequency of 50 kHz and are disposed such that the phases are displaced by 180°. Approximately 2 mL of Contaminon N was added to this water tank.

(4) The beaker in (2) was set into the beaker holder opening on the ultrasound disperser and the ultrasound disperser was started. The vertical position of the beaker was adjusted in such a manner that the resonance condition of the surface of the aqueous electrolyte solution within the beaker was at a maximum.

(5) While the aqueous electrolyte solution within the beaker of (4) was being irradiated with ultrasound, approximately 10 mg of the toner was added to the aqueous electrolyte solution in small aliquots and dispersion was carried out. The ultrasound dispersion treatment was continued for an additional 60 seconds. The water temperature in the water tank was controlled as appropriate during ultrasound dispersion to be at least 10° C. and not more than 40° C.

(6) Using a pipette, the dispersed toner-containing aqueous electrolyte solution of (5) was dripped into the roundbottom beaker set in the sample stand as described in (1) with adjustment to provide a measurement concentration of approximately 5%. Measurement was then performed until the number of measured particles reached 50,000.

(7) The measurement data was analyzed by the previously cited dedicated software provided with the instrument and the weight-average particle diameter (D4) was calculated. When set to graph/volume % with the dedicated software, the “average diameter” on the analysis/volumetric statistical value (arithmetic average) screen was the weight-average particle diameter (D4).

Method for Measuring the Average Circularity of the Toner

The average circularity of the toner was measured with the “FPIA-3000” (Sysmex Corporation), a flow-type particle image analyzer, using the measurement and analysis conditions from the calibration process.

The “FPIA-3000” flow-type particle image analyzer (Sysmex Corporation) uses a measurement principle based on taking a still image of the flowing particles and performing image analysis. The sample added to the sample chamber is delivered by a sample suction syringe into a flat sheath flow cell. The sample delivered into the flat sheath flow is sandwiched by the sheath liquid to form a flat flow. The sample passing through the flat sheath flow cell is exposed to stroboscopic light at an interval of 1/60 second, thus enabling a still image of the flowing particles to be photographed. Moreover, since flat flow is occurring, the photograph is taken under in-focus conditions. The particle image is photographed with a CCD camera; the photographed image is 512 pixels×512 pixels per visual field and is subjected to image processing at an image processing resolution of 0.37×0.37 μm per pixel; contour definition is performed on each particle image; and the projected area, the periphery length, and so forth are measured on the particle image.

The projected area S and the periphery length L are then determined for each particle image. The circle-equivalent diameter and the circularity are determined using this area S and periphery length L. The circle-equivalent diameter is the diameter of the circle that has the same area as the projected area of the particle image, and the circularity is defined as the value provided by dividing the circumference of the circle determined from the circle-equivalent diameter by the periphery length of the particle's projected image and is calculated using the following formula.

circularity C=2×(π×S)^{1/2}/L

The circularity is 1.000 when the particle image is a true circle, and the value of the circularity declines as the degree of unevenness in the periphery of the particle image increases.

After the circularity of each particle has been calculated, the circularity range from 0.2 to 1.0 is divided into 800 partitioned channels, and the average circularity is calculated by calculating the average value using the central value of each channel as the representative value.

The specific measurement method is as follows. 0.02 g of a surfactant, preferably sodium dodecylbenzenesulfonate, was added as a dispersing agent to 20 mL of deionized water; 0.02 g of the measurement sample was then added; and a dispersion for submission to measurement was made by carrying out a dispersion treatment for 2 minutes using a benchtop ultrasound cleaner/disperser having an oscillation frequency of 50 kHz and an electrical output of 150 W (for example, a “VS-150” (Velvo-Clear Co., Ltd.)). Cooling is carried out as appropriate during this treatment so as to provide a dispersion temperature of at least 10° C. and no more than 40° C.

The previously cited flow-type particle image analyzer fitted with a standard objective lens (10×) was used for the measurement, and Particle Sheath “PSE-900A” (Sysmex Corporation) was used for the sheath solution. The dispersion prepared according to the procedure described above was introduced into the flow-type particle image analyzer and 3,000 toner particles were measured according to total count mode in HPF measurement mode. The average circularity of the toner was determined with the binarization threshold value during particle analysis set at 85% and with the analyzed particle diameter limited to a circle-equivalent diameter of at least 2.00 μm and not more than 200.00 μm.

For this measurement, automatic focal point adjustment is performed prior to the start of the measurement using reference latex particles (for example, a dilution with deionized water of 5200A from Duke Scientific Corporation). After this, focal point adjustment is preferably performed every two hours after the start of measurement.

In the examples in the present application, the flow-type particle image analyzer used had been calibrated and issued a calibration certificate by the Sysmex Corporation. The measurements were carried out under the same measurement and analysis conditions as when the calibration certificate was received, with the exception that the analyzed particle diameter was limited to a circle-equivalent diameter of at least 2.00 μm and not more than 200.00 μm.

Measurement of the Glass Transition Temperature (Tg) of the Resins

The glass transition temperature of the resins is measured based on ASTM D3418-82 using a “Q2000” differential scanning calorimeter (TA Instruments).

Temperature correction in the instrument detection section is performed using the melting points of indium and zinc, and the amount of heat is corrected using the heat of fusion of indium.

Specifically, approximately 5 mg of the resin is exactly weighed out and is introduced into an aluminum pan, and the measurement is run at a ramp rate of 10° C./minute in the measurement range between 30° C. and 200° C. using an empty aluminum pan as reference. The measurement is carried out by initially raising the temperature to 180° C., holding for 10 minutes, then cooling to 30° C., and subsequently reheating. The change in the specific heat is obtained in the 30° C. to 100° C. temperature range in this second ramp-up process. In this case, the glass transition temperature (Tg) of the resin is taken to be the point at the intersection between the differential heat curve and the line for the midpoint for the baselines for prior to and subsequent to the appearance of the change in the specific heat.

Method for Measuring the Peaks A1, B1, A2, and B2 for the Inorganic Fine Particles on the Toner Particle Surface

Observation of the inorganic fine particles on the toner surface was used to determine the peaks A1, B1, A2, and B2 in the numerical distribution of the particle diameter of the primary particles of the inorganic fine particles on the toner particle surface. Using an “S-4700” (Hitachi, Ltd.) scanning electron microscope (SEM) and adjusting the observation magnification as appropriate in conformity to the size of the inorganic fine particles, the long diameter of the primary particles of the inorganic fine particles present on 100 of the toner was measured in a visual field enlarged to a maximum of 200,000×. The numerical distribution of the measured long diameters (abundance (number %) on the vertical axis, particle diameter on the horizontal axis) was plotted, and A1 was assigned to the peak in the range of particle diameters less than 70 nm and B1 was assigned to the peak in the range of particle diameters equal to and greater than 70 nm. A2 and B2 were determined by carrying out the same observation on the toner after it had been subjected to the water wash treatment. HB1, HB2 and the proportion of particles in the particle diameter range of at least 5 nm and not more than 30 nm were calculated from the obtained numerical distributions for the inorganic fine particles.

Method for Measuring the Immobilization Percentage of the Inorganic Fine Particles on the Toner Particle Surface

The immobilized inorganic fine particles are determined as follows for the present invention.

A dispersion is prepared by introducing, into a 30-cc glass vial (for example, VCV-30 from Nichiden-Rika Glass Co., Ltd., outer diameter: 35 mm, height: 70 mm), 6 cc of the surfactant Contaminon N (neutral pH 7 detergent for cleaning precision measurement instrumentation, comprising a nonionic surfactant, anionic surfactant, and organic builder, Wako Pure Chemical Industries, Ltd.) into an aqueous sucrose solution of 20.7 g of sucrose (Kishida Chemical Co., Ltd.) dissolved in 10.3 g of deionized water, and thoroughly mixing. 1.0 g of the toner is added to this vial and standing at quiescence is carried out until the toner has naturally sedimented, thus yielding the pre-treatment dispersion. This dispersion is shaken for 5 minutes at a shaking rate of 200 rpm using a shaker (YS-8D, Yayoi Co., Ltd.). The inorganic fine particles that have not detached even after this shaking are regarded as immobilized. A centrifugal separator is used to separate the detached inorganic fine particles from the toner still bearing inorganic fine particles. This centrifugal separation step is carried out for 30 minutes at 3,700 rpm. The toner still bearing inorganic fine particles is recovered by suction filtration and is dried to obtain the post-separation toner.

For the case of, for example, silica fine particles, measurement of the immobilization percentage may proceed as follows. Quantitation of the silica fine particles contained by the toner prior to the aforementioned separation step is carried out first. For this, the intensity for the element Si in the toner particle, designated as Si-B, is measured using an Axios Advanced (PANalytical B.V.) wavelength-dispersive x-ray fluorescence analyzer. The intensity for the element Si in the toner after the aforementioned separation step, designated as Si-A, is then similarly measured. The immobilization percentage is determined using (Si-A/Si-B)×100(%). For an inorganic fine particle having a different composition, the determination can be performed by carrying out the same measurement on an element constituting the inorganic fine particle.

### EXAMPLES

The present invention is specifically described herebelow based on examples. However, the present invention is in no way limited thereto or thereby. Unless specifically indicated otherwise, parts in the blends in the following examples is on a mass basis.

### Binder Resin A Production Example

| | | |
|---|---|---|
| polyoxypropylene(2.2)-2,2-bis(4-hydroxyphenyl)propane | 72.0 | parts |
| (0.20 mole, 100.0 mol % with reference to the total | | |
| number of moles of polyhydric alcohol) | | |
| terephthalic acid (0.17 mole, 94.4 mol % with reference | 28.0 | parts |
| to the total number of moles of polybasic carboxylic acid) | | |
| tin 2-ethylhexanoate (esterification catalyst) | 0.5 | parts |

These materials were weighed into a reactor fitted with a condenser, stirrer, nitrogen introduction line, and thermocouple. The interior of the flask was then substituted with nitrogen gas, followed by gradually raising the temperature while stirring and then reacting for 4 hours at a temperature of 200° C. while stirring.

The pressure within the reactor was subsequently dropped to 8.3 kPa and holding was carried out for 1 hour, followed by cooling to 180° C. and return to atmospheric pressure (first reaction step).

| | |
|---|---|
| trimellitic anhydride (0.01 mole, 5.6 mol % with reference | 1.3 parts |
| to the total number of moles of polybasic carboxylic acid) | |
| tert-butylcatechol (polymerization inhibitor) | 0.1 parts |

These materials were then added; the pressure in the reactor was dropped to 8.3 kPa and holding the temperature at 180° C. was continued; a reaction was run for 1 hour; and, once it had been confirmed that the softening point as measured according to ASTM D36-86 had reached 120° C., the reaction was stopped by cooling (second reaction step), thereby yielding a binder resin A having Tg=57° C.

### Silica Fine Particle Production Examples

### Silica Fine Particle (Inorganic Fine Particle) A1 Production Example

Silica fine particles were obtained as follows: oxygen gas was fed to a burner; the ignition burner was ignited and hydrogen gas was then fed to the burner to form a flame; and silicon tetrachloride was introduced as the starting material into this flame and gasified. The obtained silica fine particles were transferred to an electric oven and spread into a thin layer and were then sintered by the execution of a heat treatment at 900° C. The following were specifically used in this method: a starting silicon tetrachloride gas flow rate of 130 kg/hr, a hydrogen gas flow rate of 50 Nm³/hr, an oxygen gas flow rate of 25 Nm³/hr, a silica concentration in the flame of 0.10 kg/Nm³, and a residence time of 0.005 seconds. The resulting silica fine particles were transferred to an electric oven and spread into a thin layer and were then sintered by the execution of a heat treatment at 900° C. This was followed by the execution, as a hydrophobic treatment, of a surface treatment with hexamethyldisilazane to yield a silica fine particle 1. The properties of silica fine particle 1 are given in Table 1.

### Silica Fine Particles (Inorganic Fine Particle) A2 to A5 and B1 to B5 Production Example

Silica fine particles A2 to A5 and B1 to B5 were obtained by adjusting the silicon tetrachloride flow rate, oxygen gas flow rate, hydrogen gas flow rate, silica concentration, residence time, and sintering conditions. The properties of silica fine particles A2 to A5 and B1 to B5 are given in Table 1.

TABLE 1
Properties of the silica fine particles (inorganic fine particle)

| silica fine particle | particle diameter (nm) |
|---|---|
| silica fine particle A1 | 40 |
| silica fine particle A2 | 35 |
| silica fine particle A3 | 31 |
| silica fine particle A4 | 55 |
| silica fine particle A5 | 62 |
| silica fine particle B1 | 100 |
| silica fine particle B2 | 82 |
| silica fine particle B3 | 78 |
| silica fine particle B4 | 130 |
| silica fine particle B5 | 140 |

The particle diameter in the table refers to the number-average particle diameter of the primary particles.

### Toner Production Example 1

| | | |
|---|---|---|
| binder resin A | 100 | parts |
| wax (Fischer-Tropsch wax, melting point = 90° C.) | 5 | parts |
| C. I. Pigment Blue 15:3 | 5 | parts |

The starting materials specified by this formulation were mixed using a Henschel mixer (Model FM-75, Mitsui Mining Co., Ltd.) at a rotation rate of 20 s⁻¹ for a rotation time of 5 minutes, followed by kneading with a twin-screw extruder (Model PCM-30, Ikegai Corporation) set to a temperature of 125° C. The resulting kneaded material was cooled and was coarsely pulverized to 1 mm and less using a hammer mill to provide a coarsely pulverized material. The resulting coarsely pulverized material was finely pulverized using a mechanical pulverizer (T-250, Turbo Kogyo Co., Ltd.). Classification was carried out using a rotary classifier (F-300, Hosokawa Micron Corporation) to obtain toner particles. The operating conditions for the rotary classifier were a rotational rate for the classification rotor of 150.0 s⁻¹ and a rotational rate for the dispersion rotor of 125.0 s⁻¹. The resulting toner particle 1 had a weight-average particle diameter (D4) of 6.5 μm.

| | | |
|---|---|---|
| toner particle 1 | 100 | parts |
| inorganic fine particle A1 | 5 | parts |
| inorganic fine particle B1 | 2 | parts |

The starting materials specified by this formulation were mixed using a Henschel mixer (Model FM-10C, Mitsui Mining Co., Ltd.) at a rotation rate of 50 s⁻¹ for a rotation time of 3 minutes and were then subjected to a heat treatment using the surface treatment apparatus shown in the FIGURE to obtain a heat-treated toner particle 1. The operating conditions were as follows: feed flow rate=5 kg/hr, hot air current temperature=220° C., hot air current flow rate=6 m³/minute, cold air current temperature=5° C., cold air current flow rate=4 m³/minute, absolute amount of moisture in the cold air current=3 g/m³, blower air current flow rate=20 m³/minute, and injection air flow rate=1 m³/minute.

| | | |
|---|---|---|
| heat-treated toner particle 1 | 100 | parts |
| inorganic fine particle B1 | 2 | parts |

The starting materials specified by this formulation were mixed using a Henschel mixer (Model FM-10C, Mitsui Mining Co., Ltd.) at a rotation rate of 50 s⁻¹ for a rotation time of 3 minutes to obtain the toner 1. The obtained toner 1 had an average circularity of 0.964 and a weight-average particle diameter (D4) of 6.5 μm. A summary for the obtained toner 1 is given in Table 2 and its properties are given in Table 3.

### Toner Production Examples 2 to 14 and 17 to 24

Production was carried out proceeding as in Toner Production Example 1, but changing the starting materials, the number of parts of addition, and the presence/absence of the heat treatment as indicated in Table 2. Summaries for toners 2 to 14 and 17 to 24 are given in Table 2 and their properties are given in Table 3.

### Toner Production Example 15

Toner 15 was obtained proceeding as in Toner Production Example 1, but using, in place of silica fine particle A1, a titanium fine particle 1 having a number-average primary particle diameter of 40 nm. A summary for toner 15 is given in Table 2 and its properties are given in Table 3.

### Toner Production Example 16

Toner 16 was obtained proceeding as in Toner Production Example 1, but using, in place of silica fine particle B1, a titanium fine particle 2 having a number-average primary particle diameter of 100 nm. A summary for toner 16 is given in Table 2 and its properties are given in Table 3.

TABLE 2
Formulations and production conditions for toner particle

| | | | | | | conditions for external | | | external addition | | conditions for external addition | | |
|---|---|---|---|---|---|---|---|---|---|---|---|---|---|
| | | external addition prior to heat | | | | addition prior to heat treatment | | | after heat | | after heat treatment | | |
| | | treatment | | | | | | external | treatment | | | | external |
| | toner | inorganic | | inorganic | | amount | rotation | addition | inorganic | | amount | rotation | addition |
| toner | particle | fine | | fine | | charged | rate | time | fine | | charged | rate | time |
| No. | No. | particle A | parts | particle B | parts | (kg) | (rpm) | (min) | particle B | parts | (kg) | (rpm) | (min) |
| 1 | 1 | A1 | 5.0 | B1 | 2.0 | 1.0 | 3000 | 3 | B1 | 2.0 | 1.0 | 3000 | 3 |
| 2 | 1 | A1 | 3.0 | B1 | 2.0 | 1.0 | 3000 | 3 | B1 | 2.0 | 1.0 | 3000 | 3 |
| 3 | 1 | A1 | 2.5 | B1 | 2.0 | 1.0 | 3000 | 3 | B1 | 2.0 | 1.0 | 3000 | 3 |
| 4 | 1 | A1 | 5.0 | B1 | 0.5 | 1.0 | 3000 | 3 | B1 | 2.0 | 1.0 | 3000 | 3 |
| 5 | 1 | A1 | 5.0 | B1 | 0.3 | 1.0 | 3000 | 3 | B1 | 2.0 | 1.0 | 3000 | 3 |
| 6 | 1 | A1 | 5.0 | B1 | 3.5 | 1.0 | 3000 | 3 | B1 | 2.0 | 1.0 | 3000 | 3 |
| 7 | 1 | A1 | 5.0 | B1 | 4.0 | 1.0 | 3000 | 3 | B1 | 2.0 | 1.0 | 3000 | 3 |
| 8 | 1 | A1 | 5.0 | B1 | 4.0 | 1.0 | 3000 | 3 | B1 | 3.5 | 1.0 | 3000 | 3 |
| 9 | 1 | A1 | 5.0 | B1 | 4.0 | 1.0 | 3000 | 3 | B1 | 0.5 | 1.0 | 3000 | 3 |
| 10 | 1 | A1 | 7.0 | B1 | 4.0 | 1.0 | 3000 | 3 | B1 | 2.0 | 1.0 | 3000 | 3 |
| 11 | 1 | A1 | 7.0 | B2 | 4.0 | 1.0 | 3000 | 3 | B2 | 3.5 | 1.0 | 3000 | 3 |
| 12 | 1 | A1 | 7.0 | B4 | 4.0 | 1.0 | 3000 | 3 | B4 | 3.5 | 1.0 | 3000 | 3 |
| 13 | 1 | A2 | 7.0 | B4 | 4.0 | 1.0 | 3000 | 3 | B4 | 3.5 | 1.0 | 3000 | 3 |
| 14 | 1 | A4 | 7.0 | B4 | 4.0 | 1.0 | 3000 | 3 | B4 | 3.5 | 1.0 | 3000 | 3 |
| 15 | 1 | titanium | 7.0 | B1 | 4.0 | 1.0 | 3000 | 3 | B1 | 3.5 | 1.0 | 3000 | 3 |
| | | fine | | | | | | | | | | | |
| | | particle 1 | | | | | | | | | | | |
| 16 | 1 | A1 | 7.0 | titanium | 4.0 | 1.0 | 3000 | 3 | titanium | 3.5 | 1.0 | 3000 | 3 |
| | | | | fine | | | | | fine | | | | |
| | | | | particle 2 | | | | | particle 2 | | | | |
| 17 | 1 | A3 | 7.0 | B4 | 4.0 | 1.0 | 3000 | 3 | B4 | 3.5 | 1.0 | 3000 | 3 |
| 18 | 1 | A5 | 7.5 | B4 | 4.0 | 1.0 | 3000 | 3 | B4 | 3.5 | 1.0 | 3000 | 3 |
| 19 | 1 | — | — | B4 | 4.0 | 1.0 | 3000 | 3 | B4 | 3.5 | 1.0 | 3000 | 3 |
| 20 | 1 | A4 | 7.0 | B3 | 4.0 | 1.0 | 3000 | 3 | B3 | 3.5 | 1.0 | 3000 | 3 |
| 21 | 1 | A4 | 7.0 | B5 | 4.0 | 1.0 | 3000 | 3 | B5 | 3.5 | 1.0 | 3000 | 3 |
| 22 | 1 | A4 | 7.0 | — | — | 1.0 | 3000 | 3 | — | — | — | — | — |
| 23 | 1 | A4 | 7.0 | B4 | 4.0 | 1.0 | 3000 | 3 | B4 | 4.0 | 1.0 | 3000 | 3 |
| 24 | 1 | A4 | 7.0 | B4 | 4.0 | 1.0 | 3000 | 3 | B4 | 0.3 | 1.0 | 3000 | 3 |

TABLE 3
Toner properties

| | | properties | | | | | | | | | | |
|---|---|---|---|---|---|---|---|---|---|---|---|---|
| | | | | percentage | | | | | | | | |
| | | | | for 5-30 nm | | | | | | | | |
| | toner | | | inorganic fine | | | | | | | HB2/ | immobilization |
| toner | particle | D4 | average | particles | A1 | A2 | B1 | B2 | HB1 | HB2 | HB1 × | percentage |
| No. | No. | [μm] | circularity | [number %] | [nm] | [nm] | [nm] | [nm] | number % | number % | 100 | (%) |
| 1 | 1 | 6.5 | 0.964 | 5 | 41 | 40 | 101 | 100 | 9.4 | 8.0 | 85 | 83 |
| 2 | 1 | 6.6 | 0.965 | 3 | 42 | 40 | 102 | 101 | 10.8 | 9.4 | 87 | 85 |
| 3 | 1 | 6.6 | 0.965 | 2 | 40 | 41 | 100 | 102 | 11.4 | 10.1 | 89 | 86 |
| 4 | 1 | 6.4 | 0.964 | 7 | 41 | 42 | 102 | 102 | 6.3 | 5.4 | 86 | 84 |
| 5 | 1 | 6.4 | 0.964 | 8 | 39 | 39 | 101 | 98 | 5.1 | 4.5 | 88 | 85 |
| 6 | 1 | 6.5 | 0.966 | 4 | 41 | 40 | 102 | 101 | 10.7 | 9.3 | 87 | 72 |
| 7 | 1 | 6.5 | 0.966 | 4 | 40 | 40 | 98 | 101 | 11.1 | 9.3 | 84 | 68 |
| 8 | 1 | 6.5 | 0.965 | 5 | 42 | 41 | 99 | 99 | 13.5 | 10.5 | 78 | 64 |
| 9 | 1 | 6.5 | 0.965 | 6 | 39 | 39 | 80 | 81 | 10.1 | 9.1 | 90 | 76 |
| 10 | 1 | 6.4 | 0.964 | 9 | 38 | 39 | 130 | 131 | 9.3 | 6.7 | 72 | 61 |
| 11 | 1 | 6.4 | 0.964 | 9 | 39 | 40 | 80 | 81 | 10.6 | 7.5 | 71 | 66 |
| 12 | 1 | 6.5 | 0.963 | 8 | 50 | 48 | 135 | 134 | 10.4 | 7.6 | 73 | 64 |
| 13 | 1 | 6.5 | 0.963 | 10 | 35 | 38 | 132 | 133 | 8.9 | 6.3 | 71 | 63 |
| 14 | 1 | 6.4 | 0.964 | 7 | 55 | 53 | 131 | 130 | 10.6 | 7.6 | 72 | 61 |
| 15 | 1 | 6.5 | 0.965 | 8 | 41 | 40 | 101 | 102 | 10.3 | 7.3 | 71 | 64 |
| 16 | 1 | 6.4 | 0.964 | 7 | 39 | 40 | 102 | 100 | 9.8 | 7.2 | 73 | 62 |
| 17 | 1 | 6.5 | 0.963 | 13 | 32 | 34 | 130 | 131 | 9.4 | 6.8 | 72 | 63 |
| 18 | 1 | 6.4 | 0.965 | 8 | 58 | 56 | 132 | 131 | 10.0 | 7.1 | 71 | 63 |
| 19 | 1 | 6.4 | 0.965 | 0 | — | — | 134 | 132 | 19.8 | 14.7 | 74 | 61 |
| 20 | 1 | 6.5 | 0.964 | 9 | 54 | 55 | 77 | 79 | 11.0 | 7.8 | 71 | 62 |
| 21 | 1 | 6.6 | 0.964 | 8 | 55 | 53 | 140 | 138 | 9.4 | 6.8 | 72 | 64 |
| 22 | 1 | 6.6 | 0.964 | 11 | 52 | 53 | — | — | — | — | — | 86 |
| 23 | 1 | 6.4 | 0.964 | 9 | 53 | 52 | 131 | 134 | 10.2 | 6.7 | 66 | 61 |
| 24 | 1 | 6.5 | 0.965 | 10 | 55 | 54 | 132 | 129 | 9.9 | 9.3 | 94 | 92 |

### Magnetic Core Particle Production Example

Step 1 (Weighing and Mixing Step):

Ferrite starting materials were weighed out to provide the following.

| | | |
|---|---|---|
| Fe₂O₃ | 60.2 | mass % |
| MnCO₃ | 33.9 | mass % |
| Mg(OH)₂ | 4.8 | mass % |
| SrCO₃ | 1.1 | mass % |

This was followed by pulverization and mixing for 2 hours using a dry ball mill using zirconia (10 mmØ) balls.

Step 2 (Pre-Firing Step):

After pulverization and mixing, firing was carried out for 3 hours at 1,000° C. in the atmosphere using a burner-type firing furnace to produce a pre-fired ferrite. The composition of the ferrite was as follows.

(MnO)ₐ(MgO)_{b}(SrO)_{c}(Fe₂O₃)_{d}

In this formula, a=0.39, b=0.11, c=0.01, d=0.50.

Step 3 (Pulverization Step):

After pulverization to about 0.5 mm with a crusher, pulverization was carried out for 2 hours with a wet ball mill using zirconia (10 mmØ) balls with the addition of 30 parts of water per 100 parts of the pre-fired ferrite.

The obtained slurry was milled for 4 hours using a wet ball mill using zirconia beads (1.0 mmØ) to obtain a ferrite slurry.

Step 4 (Granulation Step):

2.0 parts of polyvinyl alcohol as a binder per 100 parts of the pre-fired ferrite was added to the ferrite slurry, followed by granulation with a spray dryer (manufacturer: Ohkawara Kakohki Co., Ltd.) into approximately 36-μm spherical particles.

Step 5 (Main Firing Step):

Firing was carried out for 4 hours at 1,150° C. in an electric furnace under a nitrogen atmosphere (oxygen concentration of not more than 1.00 volume %) in order to control the firing atmosphere.

Step 6 (Classification Step):

After the aggregated particles had been crushed, the coarse particles were removed by sieving on a sieve with an aperture of 250 μm to obtain magnetic core particles.

### Coating Resin Production Example

| | | |
|---|---|---|
| cyclohexyl methacrylate monomer | 26.8 | parts |
| methyl methacrylate monomer | 0.2 | parts |
| methyl methacrylate macromonomer (macromonomer | 8.4 | parts |
| having a weight-average molecular weight of 5,000 | | |
| and having the methacryloyl group at one terminal) | | |
| toluene | 31.3 | parts |
| methyl ethyl ketone | 31.3 | parts |

These materials were added to a four-neck separable flask fitted with a reflux condenser, thermometer, nitrogen introduction line, and stirring apparatus and nitrogen gas was introduced to thoroughly convert into a nitrogen atmosphere. This was followed by heating to 80° C., the addition of 2.0 parts of azobisisobutyronitrile, and polymerization by heating under reflux for 5 hours. The copolymer was precipitated by pouring hexane into the obtained reaction product, and the precipitate was separated by filtration and then vacuum dried to obtain a coating resin.

### Magnetic Carrier 1 Production Example

| | |
|---|---|
| coating resin | 20.0 mass % |
| toluene | 80.0 mass % |

These materials were dispersed and mixed using a bead mill to obtain a resin solution.

100 parts of the aforementioned magnetic core particles was introduced into a Nauta mixer and the resin solution was also introduced into the Nauta mixer to provide 2.0 parts as the resin component. Heating was carried out under reduced pressure to a temperature of 70° C. and a solvent removal and coating process was carried out over 4 hours while mixing at 100 rpm. The obtained sample was then transferred to a Julia mixer; a heat treatment was carried out for 2 hours at a temperature of 100° C. under a nitrogen atmosphere; and classification was subsequently performed on a sieve having an aperture of 70 μm to obtain a magnetic carrier 1. The obtained magnetic carrier had a 50% particle diameter on a volume basis (D50) of 38.2 μm.

Two-component developers 1 to 24 were obtained by mixing a toner 1 to 24 with this magnetic carrier 1 using a V-mixer (Model V-10, Tokuju Corporation) at 0.5 s⁻¹ for a rotation time of 5 minutes to provide a toner concentration of 8.0 mass %. The details are given in Table 4.

TABLE 4
Developer formulations

| | toner | carrier | two-component |
|---|---|---|---|
| | No. | No. | developer No. |
| Example 1 | 1 | 1 | 1 |
| Example 2 | 2 | 1 | 2 |
| Example 3 | 3 | 1 | 3 |
| Example 4 | 4 | 1 | 4 |
| Example 5 | 5 | 1 | 5 |
| Example 6 | 6 | 1 | 6 |
| Example 7 | 7 | 1 | 7 |
| Example 8 | 8 | 1 | 8 |
| Example 9 | 9 | 1 | 9 |
| Example 10 | 10 | 1 | 10 |
| Example 11 | 11 | 1 | 11 |
| Example 12 | 12 | 1 | 12 |
| Example 13 | 13 | 1 | 13 |
| Example 14 | 14 | 1 | 14 |
| Example 15 | 15 | 1 | 15 |
| Example 16 | 16 | 1 | 16 |
| Comparative Example 1 | 17 | 1 | 17 |
| Comparative Example 2 | 18 | 1 | 18 |
| Comparative Example 3 | 19 | 1 | 19 |
| Comparative Example 4 | 20 | 1 | 20 |
| Comparative Example 5 | 21 | 1 | 21 |
| Comparative Example 6 | 22 | 1 | 22 |
| Comparative Example 7 | 23 | 1 | 23 |
| Comparative Example 8 | 24 | 1 | 24 |

### Example 1

The evaluations described below were carried out using a modified version of an imageRUNNER ADVANCE C9280 PRO, a digital printer for commercial printing service from Canon, Inc., as the image-forming apparatus. Two-component developer 1 was introduced into the developing device at the cyan position, and images were formed at the desired toner laid-on level on the paper. The modifications enabled the following to be freely settable: the process speed, the direct-current voltage V_{DC} of the developer carrying member, the charging voltage V_{D} of the electrostatic latent image bearing member, the laser power, and the transfer current. An FFh image (solid image) having the desired image ratio was output for the image output evaluations. FFh is a value that represents 256 gradations using a hexadecimal number, where 00h is the first gradation (white background area) of the 256 gradations and FFh is the 256th gradation (solid area) of the 256 gradations.

Evaluations were performed based on the following evaluation methods, and the results therefrom are given in Table 5.

Evaluation of Toner Durability

paper: CS-680 (68.0 g/m²) (Canon Marketing Japan Inc.) toner laid-on level on the paper: 0.35 mg/cm² (FFh image)
test environment: high-temperature, high-humidity environment (temperature=30° C./humidity=80% RH (H/H in the following))

For the durability image output test, 20,000 prints were output on the A4 paper using a band chart for FFh output at a 0.1% image ratio. This was followed by placing a 10 cm² image in the center of the A4 paper and measuring the post-output image density. Then, 1,000 prints were output on the A4 paper using a band chart for FFh output at a 40.0% image ratio, followed by placing a 10 cm² image in the center of the A4 paper and measuring the post-output image density. The density difference between these two evaluation images was evaluated using the following criteria. The effects of the present invention were regarded as being obtained at C and above.

### Evaluation Criteria

A: the density difference is less than 0.10
B: the density difference is at least 0.10 and less than 0.15
C: the density difference is at least 0.15 and less than 0.25
D: the density difference is equal to or greater than 0.25
E: streaks are produced during the evaluation and evaluation is not possible

Evaluation of Transferability

paper: CS-680 (68.0 g/m²) (Canon Marketing Japan Inc.) toner laid-on level on the paper: 0.35 mg/cm² (FFh image)
test environment: H/H

A 10 cm² image was placed in the center of the A4 paper and the post-output image density was measured. Then, for the image output durability test, 10,000 prints were output on the A4 paper using a band chart for FFh output at a 0.1% image ratio. The transfer current after the durability test output was set to the same value as the current prior to the durability test; a 10 cm² image was then placed in the center of the A4 paper; and the post-output image density was measured. The density difference between these two evaluation images was evaluated using the following criteria. The effects of the present invention were regarded as being obtained at C and above.

### Evaluation Criteria

A: the density difference is less than 0.10
B: the density difference is at least 0.10 and less than 0.15
C: the density difference is at least 0.15 and less than 0.25
D: the density difference is equal to or greater than 0.25

Evaluation of the Charge Stability at High Temperature and High Humidity

paper: CS-680 (68.0 g/m²) (Canon Marketing Japan Inc.) toner laid-on level on the paper: 0.35 mg/cm² (FFh image)
test environment: H/H

To evaluate the charge stability at high temperature and high humidity, 20,000 prints with an image print percentage of 40% were output in the indicated test environment. Then, the direct-current voltage V_{DC} of the developer carrying member, the charging voltage V_{D} of the electrostatic latent image bearing member, the laser power, and the transfer current were brought to the same settings as at the start of the test, and a 00h solid image (solid white image) was printed over the entire surface of the A3 paper and was evaluated using the criteria indicated below. Using a reflectometer (“Reflectometer Model TC-6DS”, Tokyo Denshoku Co., Ltd.), the average reflectance Dr (%) at 6 points on the unprinted paper and the average reflectance Ds (%) at 6 points on the printed paper were measured and the fogging (%) was determined. The effects of the present invention were regarded as being obtained at C and above.

fogging (%)=Dr (%)−Ds (%)

### Evaluation Criteria

A: fogging is less than 0.5%
B: fogging is at least 0.5% but less than 1.5%
C: fogging is at least 1.5% but less than 3.0%
D: fogging is equal to or greater than 3.0%

Evaluation of the Cleaning (CLN) Performance

In the evaluation of the CLN performance, an FFh solid image was printed over the entire side of the A3 paper after the transferability evaluation, and a visual assessment was made using the following criteria.

### Evaluation Criteria

A: white dots are not produced
B: the image has at least 1 but fewer than 5 white dots of less than or equal to 0.5 mm
C: the image has at least 5 but fewer than 10 white dots of less than or equal to 0.5 mm
D: the image has 10 or more white dots of less than or equal to 0.5 mm, or a white dot of greater than or equal to 0.5 mm is present on the image

Evaluation of the Contamination Behavior

In the evaluation of the contamination behavior, an 80h solid image was printed out over the entire side of the A3 paper after the evaluation of the charging performance at a high temperature and high humidity, and an evaluation according to the criteria given below was performed. The 80h solid image was output over the entire side of the A3 paper prior to the durability evaluation, and the average density ds at 6 points on this output image was measured. The direct-current voltage V_{DC} of the developer carrying member, the charging voltage V_{D} of the electrostatic latent image bearing member, the laser power, and the transfer current were set to the same as prior to the durability evaluation, and the average density de at 6 points on the output image after the durability evaluation was measured. The density change was determined using the following formula. The effects of the present invention were regarded as being obtained at C and above.

density change=de−ds

### Evaluation Criteria

A: the density difference is less than 0.10
B: the density difference is at least 0.10 but less than 0.15
C: the density difference is at least 0.15 but less than 0.25
D: the density difference is equal to or greater than 0.25

### Examples 2 to 16 and Comparative Examples 1 to 8

Evaluations were performed proceeding as in Example 1, but using two-component developers 2 to 24. The results of the evaluations are given in Table 5.

TABLE 5
Results of the evaluations

| | | | | | | | | CLN | | | |
|---|---|---|---|---|---|---|---|---|---|---|---|
| | | | | | | | | performance | | contamination | |
| | | toner durability | | transferability | | | | | number | behavior | |
| Example | developer | | density | | density | charge stability | | | of white | | density |
| No. | No. | rank | difference | rank | difference | rank | fogging | rank | dots | rank | difference |
| 1 | 1 | A | 0.03 | A | 0.02 | A | 0.2 | A | 0 | A | 0.03 |
| 2 | 2 | A | 0.07 | A | 0.03 | A | 0.2 | A | 0 | A | 0.04 |
| 3 | 3 | A | 0.08 | A | 0.05 | A | 0.1 | A | 0 | A | 0.05 |
| 4 | 4 | A | 0.09 | B | 0.11 | A | 0.2 | A | 0 | A | 0.07 |
| 5 | 5 | A | 0.08 | B | 0.13 | A | 0.2 | A | 0 | A | 0.06 |
| 6 | 6 | A | 0.04 | A | 0.04 | A | 0.3 | A | 0 | B | 0.10 |
| 7 | 7 | A | 0.05 | A | 0.03 | A | 0.4 | A | 0 | B | 0.12 |
| 8 | 8 | A | 0.07 | A | 0.04 | A | 0.3 | A | 0 | C | 0.16 |
| 9 | 9 | A | 0.06 | A | 0.08 | B | 0.6 | B | 1 | B | 0.13 |
| 10 | 10 | A | 0.08 | A | 0.09 | B | 0.7 | A | 0 | C | 0.23 |
| 11 | 11 | B | 0.11 | B | 0.12 | B | 0.6 | A | 0 | C | 0.21 |
| 12 | 12 | A | 0.07 | A | 0.08 | B | 0.8 | B | 2 | C | 0.18 |
| 13 | 13 | B | 0.12 | C | 0.15 | C | 1.6 | B | 1 | B | 0.13 |
| 14 | 14 | B | 0.11 | B | 0.14 | B | 1.1 | C | 5 | B | 0.12 |
| 15 | 15 | C | 0.22 | B | 0.12 | C | 1.7 | B | 3 | B | 0.14 |
| 16 | 16 | C | 0.17 | B | 0.13 | C | 1.6 | B | 3 | B | 0.12 |
| Comparative 1 | 17 | D | 0.25 | C | 0.21 | D | 3.1 | C | 6 | C | 0.16 |
| Comparative 2 | 18 | E | — | C | 0.17 | C | 2.4 | C | 7 | C | 0.21 |
| Comparative 3 | 19 | E | — | C | 0.19 | C | 2.3 | C | 5 | C | 0.23 |
| Comparative 4 | 20 | D | 0.27 | D | 0.26 | C | 2.6 | D | 12 | C | 0.19 |
| Comparative 5 | 21 | C | 0.22 | C | 0.22 | C | 2.4 | C | 8 | D | 0.25 |
| Comparative 6 | 22 | D | 0.28 | D | 0.29 | C | 2.6 | D | 13 | B | 0.14 |
| Comparative 7 | 23 | C | 0.21 | C | 0.16 | D | 3.2 | C | 8 | D | 0.26 |
| Comparative 8 | 24 | C | 0.22 | C | 0.18 | C | 1.8 | D | 15 | C | 0.21 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-54301, filed Mar. 21, 2017, which is hereby incorporated by reference herein in its entirety.

What is claimed is:

1. A toner comprising:
a toner particle containing a binder resin and a colorant; and
inorganic fine particles present on the surface of the toner particle, wherein
particle diameter numerical distribution of primary particles of the inorganic fine particles on the toner particle surface has a peak A1 present in a particle diameter range of at least 35 nm and not more than 55 nm, and a peak B1 present in a particle diameter range of at least 80 nm and not more than 135 nm;
in this numerical distribution, the proportion of inorganic fine particles in a particle diameter range of at least 5 nm and not more than 30 nm, with reference to a total number of inorganic fine particles in a particle diameter range of at least 5 nm and not more than 200 nm, is not more than 10 number %;
after the toner has been subjected to a water wash treatment, the particle diameter numerical distribution of the primary particles of the inorganic fine particles on the toner particle surface has a peak A2 present in the particle diameter range of at least 35 nm and not more than 55 nm and a peak B2 present in the particle diameter range of at least 80 nm and not more than 135 nm;
when HB1 (number %) is a peak value of the peak B1 and HB2 (number %) is ae peak value of the peak B2,
70≤(HB2/HB1)×100≤90 is satisfied; and
the water wash treatment is a treatment in which a dispersion obtained by addition of the toner to surfactant-containing deionized water is shaken for 5 minutes under a condition of a shaking speed of 46.7 cm/second and a shaking amplitude of 4.0 cm.

2. The toner according to claim 1, wherein the inorganic fine particles contain silica fine particles.

3. The toner according to claim 1, wherein the immobilization percentage of the inorganic fine particles on the toner particle surface is at least 70% with respect to the toner after the water wash treatment.

4. The toner according to claim 1, wherein the binder resin contains a polyester resin.

5. A method of producing the toner according to claim 1,
the toner production method comprising a step of carrying out an external addition of the inorganic fine particles to the toner particle surface and performing a heat treatment.
